(19) United States
(12) Patent Application Publication
(10) Pub. No.: US 2008/0181090 A1
(43) Pub. Date: Jul. 31, 2008

(54) Objective lens optical system and light beam splitting element

(75) Inventors: Mitsuhiro Miyauchi, Ibaraki-shi (JP); Koichiro Wakabayashi, Ibaraki-shi (JP); Yoshikazu Mitsui, Ibaraki-shi (JP); Tomonori Kanai, Ibaraki-shi (JP); Yasuyuki Sugi, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., IBARAKI-SHI (JP)

(21) Appl. No.: 11/979,333

(22) Filed: Nov. 1, 2007

(30) Foreign Application Priority Data
Nov. 2, 2006 (JP) 2006-299643
Nov. 2, 2006 (JP) 2006-299644

(51) Int. Cl. G11B 7/00

(52) U.S. Cl. 369/112.25

(57) ABSTRACT

An objective lens optical system includes a light beam splitting element and an objective lens and is configured to focus a light beam with a wavelength λ on an information recording surface of a first optical recording medium as a dual/double layer disc having a transparent substrate with a thickness t1 and to focus a light beam with a wavelength λ on an information recording surface of a second optical recording medium as a dual/double layer disc having a transparent substrate with a thickness t2 (t1<t2). The light beam splitting element is sectioned into regions that are designed to focus a light beams on an information recording surface of either one of the first optical recording medium and the second optical recording medium. Either one region has a negative or positive power so that a light focus position of a light beam having passed through the first region by the objective lens and a light focus position of a light beam having passed through the second region by the objective lens are different.

### INCORPORATION BY REFERENCE

The disclosure of U.S. patent application Ser. No. 11/797,481 filed on May 3, 2007 including the specification, drawings and abstract is incorporated herein by reference in its entirety.

### BACKGROUND OF THE INVENTION

1. Field of the Invention

The present invention relates to an objective lens optical system and a light beam splitting element that enable recording or playback of information on a plurality of kinds of optical recording media having different thicknesses.

2. Description of Related Art

Compatible optical disc apparatus that is capable of playing back different kinds of optical discs such as a CD (Compact Disc, including CD-R or the like) and a DVD (Digital Versatile Disc) have been proposed. A CD and a DVD (which are collectively referred to hereinafter as optical discs) both include a transparent substrate, one face of which has an information recording surface. An optical disc has the structure that such two transparent substrates are adhered to each other with the information recording surfaces facing each other, or such a transparent substrate is adhered to a transparent protective substrate with the information recording surface of the transparent substrate facing the protective substrate.

In order to play back an information signal which is stored in an optical disc having such a structure, it is necessary to focus a laser beam from a light source on an information recording surface of the optical disc through a transparent substrate using an optical disc apparatus. When playing back a CD, a laser beam with a wavelength of about 780 nm and an objective lens with a numerical aperture NA of 0.45 to 0.53 are used. When playing back a DVD, a laser beam with a wavelength of about 650 nm and an objective lens with a numerical aperture NA of 0.60 to 0.67 are used. The thickness of a transparent substrate which is used in a CD is 1.2 mm, and the thickness of a transparent substrate which is used in a DVD is 0.6 mm. The thickness of a transparent substrate having an information recording surface thus differs with the kind of optical discs (or a difference in the wavelength of a laser beam). A compatible optical disc apparatus which plays back different kinds of optical discs needs to focus a laser beam on an information recording surface even if the thickness of a transparent substrate differs with the kind of optical discs.

Such a compatible optical disc apparatus may have a plurality of objective lenses corresponding to the kinds of optical discs in a pickup so that the objective lenses can change according to the kind of an optical disc in use, or have a plurality of pickups corresponding to the kinds of optical discs so that the pickups can change according to the kind of an optical disc in use. However, for cost and size reduction of an apparatus, it is preferred to use the same objective lens for any kinds of optical discs.

A typical example of such an objective lens is disclosed in Japanese Unexamined Patent Application Publication No. 9-145995. The objective lens that is described therein is sectioned into three or more loop zonal lens surfaces in the radial direction, and one set of every other loop zonal lens surfaces and another set of every other zonal lens surfaces have different refractive powers. One set of every other loop zonal lens surfaces focuses a laser beam with a certain wavelength on an information recording surface of an optical disc (DVD) having a thin transparent substrate (0.6 mm), for example, and another set of every other zonal lens surfaces focuses a laser beam with the same wavelength on an information recording surface of an optical disc (CD) having a thick transparent substrate (1.2 mm), for example.

Another typical example is disclosed in Japanese Unexamined Patent Application Publication No. 2000-81566. This document discloses an optical disc apparatus which uses a laser beam with a short wavelength (635 nm or 650 nm) for a DVD having a thin transparent substrate and uses a laser beam with a long wavelength (780 nm) for a CD having a thick transparent substrate. The optical disc apparatus includes an objective lens which is used in common for those laser beams. The objective lens has a diffractive lens structure in which fine loop zonal steps are formed in close proximity to each other on one surface of a refractive lens having a positive power. Such a diffractive lens structure is designed to focus diffracted light of a laser beam with a short wavelength on an information recording surface of a DVD having a thin transparent substrate and to focus diffracted light of a laser beam with a long wavelength on an information recording surface of a CD having a thick transparent substrate. It is designed to focus the diffracted light of the same order on each information recording surface. A laser beam with a short wavelength is used for a DVD because the recording density of a DVD is higher than that of a CD and it is therefore necessary to narrow a beam spot. As well known, the size of an optical spot is proportional to a wavelength and is inversely proportional to a numerical aperture NA.

Another typical example is disclosed in Japanese Unexamined Patent Application Publication No. 7-302437. This document discloses an objective lens of an optical disc apparatus which uses a laser beam with a short wavelength (680 nm) for a thin transparent substrate of 0.6 mm and uses a laser beam with a long wavelength (780 nm) for a thick transparent substrate of 1.2 mm. In this objective lens, a lens surface is sectioned into a plurality of ring regions, and one region focuses light with one wavelength on an optical disc having one substrate thickness.

A new optical disc apparatus which has been proposed recently is a Blu-ray/HDDVD compatible optical disc apparatus which uses blue laser with a wavelength of about 450 nm in order to increase the recording density. When playing back a Blu-ray Disc, a laser beam with a wavelength of 405 to 408 nm and an objective lens with NA of 0.85 are used. The thickness of a transparent substrate of a Blu-ray Disc is 0.075 to 0.1 mm for both a dual/double layer optical disc and a single layer optical disc. When playing back an HDDVD, a laser beam with a wavelength of 405 to 408 nm and an objective lens with NA of 0.65 are used. The thickness of a transparent substrate of an HDDVD is 0.6 mm. There is thus a demand for an apparatus that is compatible with the two kinds of optical discs having different thicknesses which are recorded or played back with a laser beam of the same wavelength.

Although Japanese Unexamined Patent Application Publication No. 9-145995 includes a description regarding a DVD and a CD, it does not include a description about a Blu-ray Disc, an HDDVD or the like. Wavefront aberration for the same ray aberration (mm) increases in inverse proportion to a wavelength when the wavelength of a laser in use is short, and the third-order spherical aberration increases in proportion to the fourth power of NA, for example, when NA is large. Consequently, aberration correction becomes more difficult.

It is thus difficult for the technique disclosed in Japanese Unexamined Patent Application Publication No. 9-145995 to obtain a desired shape of an optical spot by focusing light using the same objective lens, objective lens optical system or optical pickup optical system for a Blu-ray Disc and an HDDVD with a different wavelength and NA from a DVD and a CD, which are a Blu-ray and an HDDVD that require a shorter wavelength and a larger NA than a DVD and a CD that are described in Japanese Unexamined Patent Application Publication No. 9-145995.

Further, because Japanese Unexamined Patent Application Publication No. 2000-81566 uses diffracted light in the diffractive lens structure, it is impossible to deal with transparent substrates with different thicknesses without using light beams with different wavelengths. Accordingly, the technique of Japanese Unexamined Patent Application Publication No. 2000-81566 cannot be used if the thickness of a transparent substrate is different and the wavelength is the same or substantially the same. Further, Japanese Unexamined Patent Application Publication No. 7-302437 does not disclose a technique for enabling compatibility between two kinds of optical discs having different thicknesses which are recorded or played back with a light beam of the same wavelength.

The inventors of the present invention proposed the objective lens optical system which overcomes such drawbacks of the related arts in Japanese Patent Application No. 2006-134311. However, because an aberration correction plate does not have a power in this objective lens optical system, the focal length of an optical system that is composed of a Blu-ray region and an objective lens and the focal length of an optical system that is composed of an HDDVD region and an objective lens are equal. When recording or playing back information of a Blu-ray Disc in this system, an image focus position of a light beam having passed through the HDDVD region does not appear as a single point but as fluctuation because of the effect of spherical aberration due to a difference in thickness. Likewise, when recording or playing back information of an HDDVD in this system, an image focus location of a light beam having passed through the Blu-ray region does not appear as a single point but as fluctuation because of the effect of spherical aberration due to a difference in thickness.

In order to increase the recording density of a Blu-ray Disc and an HDDVD, a dual/double layer disc which has two information recording surfaces has been developed and put to practical use. However, the inventors of the present invention found that the deviation of the image focus position, which is the generation of a false spot, presents a problem when recording or playing back such a dual/double layer disc. The problem is that, when recording or playing back a Blu-ray Disc, an image focus position of a light beam having passed through the HDDVD region is located on a layer that is different from a layer to record or play back, which leads to accidental writing or erasure, focus servo error and so on. Likewise, when recording or playing back an HDDVD, an image focus position of a light beam having passed through the Blu-ray region is located on a layer that is different from a layer to record or play back, which leads to accidental writing or erasure, focus servo error and so on.

Further, because the aberration correction plate does not have a power in the U.S. patent application Ser. No. 11/797,481 that is proposed by the inventors of the present invention, a focal length is the same between the Blu-ray region and the HDDVD region. A transparent substrate of an HDDVD is thicker than that of a Blu-ray Disc, so that a working distance is shorter in an HDDVD. This raises a problem that an optical head and a disc come into contact when recording or playing back an HDDVD.

### SUMMARY OF THE INVENTION

The present invention has been accomplished to solve the above problems and an object of the present invention is thus to provide an objective lens optical system and a light beam splitting element that enable recording or playback of optical recording media having different thicknesses and including at least two information recording surfaces with a light beam of the same wavelength.

Further, the present invention has been accomplished to solve the above problems and an object of the present invention is thus to provide an objective lens optical system and a light beam splitting element that enable recording or playback of optical recording media having different thicknesses with a light beam of the same wavelength while maintaining a sufficient working distance. Furthermore, an object of the present invention is to provide an objective lens optical system and a light beam splitting element that enable recording or playback of optical recording media including two or a plurality of layers.

According to one aspect of the present invention, there is provided an objective lens optical system including a light beam splitting element and an objective lens, and configured to focus a light beam with a wavelength λ on an information recording surface of a first optical recording medium having a transparent substrate with a thickness t1 and to focus a light beam with a wavelength λ on an information recording surface of a second optical recording medium having a transparent substrate with a thickness t2 (t1<t2). In this objective lens optical system, one of the first optical recording medium and the second optical recording medium includes two or more layers of information recording surfaces, at least one surface of the light beam splitting element is sectioned into a first region designed to focus a light beam on an information recording surface of the first optical recording medium through the objective lens, and a second region designed to focus a light beam on an information recording surface of the second optical recording medium through the objective lens, and at least one region has a negative or positive power to prevent a light beam having passed through one of the first region and the second region from being focused near a light focus position of a light beam having passed through another one of the first region and the second region in a corresponding optical recording medium.

In the above objective lens optical system, it is preferred that the first optical recording medium at least includes a first information recording surface and a second information recording surface, and a surface shape of each region is designed to suppress a light beam having passed through the second region from being focused on the second information recording surface of the first optical recording medium when focusing a light beam on the first information recording surface of the first optical recording medium.

It is also preferred that the second optical recording medium at least includes a first information recording surface and a second information recording surface, and a surface shape of each region is designed to suppress a light beam having passed through the first region from being focused on the second information recording surface of the second optical recording medium when focusing a light beam on the first information recording surface of the second optical recording medium.

A surface shape of each region is preferably designed to suppress a light beam having passed through the second region from being focused on ranges from t1+0.015 mm to t1+0.035 mm and from t1−0.015 mm to t1−0.035 mm when focusing a light beam on an information recording surface of the first optical recording medium, and to suppress a light beam having passed through the first region from being focused on ranges from t2+0.015 mm to t2+0.035 mm and from t2−0.015 mm to t2−0.035 mm when focusing a light beam on an information recording surface of the second optical recording medium.

Particularly, the second region preferably has a curvature radius so as to act as a concave lens. The second region may have a diffractive structure.

The first region preferably has a flat surface. It is also preferred that one region of a plurality of first regions has a different height from another region in an optical axis direction, and a difference in the height is mλ (m is an integer). Also preferably, a surface of the light beam splitting element opposite to the surface sectioned into a plurality of regions is a flat surface.

In a preferred embodiment, a plurality of regions formed on one surface of the light beam splitting element are sectioned concentrically with an optical axis. Further, a focal length for the second optical recording medium is preferably longer than a focal length for the first optical recording medium. More preferably, the number of the plurality of regions is five or more. It is also preferred that a lens surface of the objective lens is designed to correct aberration for the first optical recording medium. The aberration is corrected to reduce RMS wavefront aberration to 0.070 λrms or lower, or more preferably, 0.040 λrms or lower so that aberration of an entire optical pickup is 0.070 λrms or lower. Preferably, a numerical aperture NA corresponding to the first optical recording medium is larger than a numerical aperture NA corresponding to the second optical recording medium.

According to another aspect of the present invention, there is provided a light beam splitting element disposed on a light incident side of an objective lens, and configured to focus a light beam with a wavelength λ on an information recording surface of a first optical recording medium having a transparent substrate with a thickness t1 and to focus a light beam with a wavelength λ on an information recording surface of a second optical recording medium having a transparent substrate with a thickness t2 (t1<t2). In this light beam splitting element, one of the first optical recording medium and the second optical recording medium includes two or more layers of information recording surfaces, at least one surface of the light beam splitting element is sectioned into a first region designed to focus a light beam on an information recording surface of the first optical recording medium through the objective lens, and a second region designed to focus a light beam on an information recording surface of the second optical recording medium through the objective lens, and at least one region has a negative or positive power to prevent a light beam having passed through one of the first region and the second region from being focused near a light focus position of a light beam having passed through another one of the first region and the second region in a corresponding optical recording medium.

According to yet another aspect of the present invention, there is provided an objective lens optical system including a light beam splitting element and an objective lens, and configured to focus a light beam with a wavelength λ on an information recording surface of a first optical recording medium having a transparent substrate with a thickness t1 and to focus a light beam with a wavelength λ on an information recording surface of a second optical recording medium having a transparent substrate with a thickness t2 (t1<t2). In this objective lens optical system, at least one surface of the light beam splitting element is sectioned into a first region designed to focus a light beam on an information recording surface of the first optical recording medium through the objective lens, and a second region designed to focus a light beam on an information recording surface of the second optical recording medium through the objective lens, and the second region has a negative power.

The second region preferably has a curvature radius so as to act as a concave lens. The first region may have a smaller negative power than the second region. The second region may have a diffractive structure.

The first region preferably has a flat surface. Further, one region of a plurality of first regions may have a different height from another region in an optical axis direction, and a difference in the height may be mλ (m is an integer).

It is also preferred that a surface of the light beam splitting element opposite to the surface sectioned into a plurality of regions is a flat surface.

In a preferred embodiment, a plurality of regions formed on one surface of the light beam splitting element are sectioned concentrically with an optical axis. Further, a focal length for the second optical recording medium is longer than a focal length for the first optical recording medium.

It is also preferred that a lens surface of the objective lens is designed to correct aberration for the first optical recording medium. The aberration is corrected to reduce RMS wavefront aberration to 0.070 λrms or lower, or more preferably, 0.040 λrms or lower so that aberration of an entire optical pickup is 0.070 λrms or lower.

According to still another aspect of the present invention, there is provided a light beam splitting element disposed on a light incident side of an objective lens, and configured to focus a light beam with a wavelength λ on an information recording surface of a first optical recording medium having a transparent substrate with a thickness t1 and to focus a light beam with a wavelength λ on an information recording surface of a second optical recording medium having a transparent substrate with a thickness t2 (t1<t2). In this light beam splitting element, at least one surface of the light beam splitting element is sectioned into a first region designed to focus a light beam on an information recording surface of the first optical recording medium through the objective lens, and a second region designed to focus a light beam on an information recording surface of the second optical recording medium through the objective lens, and the second region has a negative power.

The present invention provides an objective lens optical system and a light beam splitting element that enable recording or playback of optical recording media having different thicknesses and including at least two information recording surfaces with a light beam of the same wavelength.

The present invention also provides an objective lens optical system and a light beam splitting element that enable recording or playback of optical recording media having different thicknesses with a light beam of the same wavelength while maintaining a sufficient working distance.

The present invention further provides an objective lens optical system and a light beam splitting element that enable recording or playback of optical recording media including two or a plurality of layers.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic structural view of an objective lens optical system according to an embodiment of the present invention;

FIG. 2 is a view to describe a problem in recording or playback of a dual/double layer disc with use of an objective lens optical system according to an embodiment of the present invention;

FIG. 3 is a view to describe a problem in recording or playback of a dual/double layer disc with use of an objective lens optical system according to an embodiment of the present invention;

FIG. 4 is an optical spot chart when applying a light beam for a Blu-ray Disc to an objective lens optical system according to an example of the present invention;

FIG. 5 is an optical spot chart when applying a light beam for an HDDVD to an objective lens optical system according to an example of the present invention;

FIG. 6 is a graph showing the dependence of a light intensity on a disc thickness when applying a light beam for a Blu-ray Disc to an objective lens optical system according to an example of the present invention;

FIG. 7 is a graph showing the dependence of a light intensity on a disc thickness when applying a light beam for a Blu-ray Disc to an objective lens optical system according to an example of the present invention;

FIG. 8 is a graph showing the dependence of a light intensity on a disc thickness when applying a light beam for an HDDVD to an objective lens optical system according to an example of the present invention;

FIG. 9 is a graph showing the dependence of a light intensity on a disc thickness when applying a light beam for an HDDVD to an objective lens optical system according to an example of the present invention;

FIG. 10 is an optical spot chart when applying a light beam for a Blu-ray Disc to an objective lens optical system according to a comparative example;

FIG. 11 is an optical spot chart when applying a light beam for an HDDVD to an objective lens optical system according to a comparative example;

FIG. 12A is an enlarged view showing a part of a light beam splitting element according to an embodiment of the present invention;

FIG. 12B is an enlarged view showing a part of a light beam splitting element according to an embodiment of the present invention;

FIG. 12C is an enlarged view showing a part of a light beam splitting element according to an embodiment of the present invention;

FIG. 13 is a comparative table of the specifications of a Blu-ray Disc and an HDDVD;

FIG. 14 is a table showing design data of an objective lens optical system according to an example of the present invention;

FIG. 15 is a table showing lens data of an objective lens optical system according to an example of the present invention;

FIG. 16 is a table showing surface shape data of an objective lens according to an example of the present invention;

FIG. 17 is a table showing surface shape data of a light beam splitting element according to an example of the present invention;

FIG. 18 is a table showing the position of regions in a light beam splitting element according to an example of the present invention;

FIG. 19 is a table showing design data of an objective lens optical system according to a comparative example;

FIG. 20 is a table showing lens data of an objective lens optical system according to a comparative example;

FIG. 21 is a table showing surface shape data of an objective lens according to a comparative example;

FIG. 22 is a table showing surface shape data of a light beam splitting element according to a comparative example;

FIG. 23 is a table showing the position of regions in a light beam splitting element according to a comparative example;

FIG. 24A is a view showing light rays in a light beam splitting element according to an example of the present invention and a comparative example; and

FIG. 24B is a view showing light rays in a light beam splitting element according to an example of the present invention and a comparative example.

### DESCRIPTION OF THE PREFERRED EMBODIMENTS

An embodiment of the present invention is described hereinafter in detail with reference to the drawings.

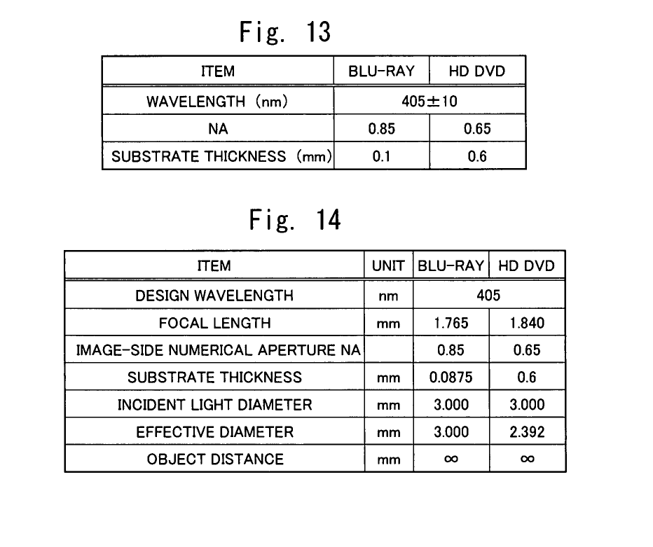

FIG. 13 shows the specifications of a Blu-ray Disc and an HDDVD in an objective lens optical system according to an embodiment of the present invention. As shown in FIG. 13, although a wavelength is the same for both a Blu-ray Disc and an HDDVD, the thickness of a substrate is different. Therefore, when an objective lens that is designed to be optimal for one kind of optical disc is used for another kind of optical disc, spherical aberration occurs due to a difference in substrate thickness, which hampers suitable recording and playback. The objective lens optical system of this embodiment includes a light beam splitting element in order to suppress the occurrence of such spherical aberration.

A Blu-ray Disc and an HDDVD which are used in this embodiment are so-called dual/double layer discs with two layers of information recording surfaces. An objective lens system of the present invention is applicable to a disc with three or more layers.

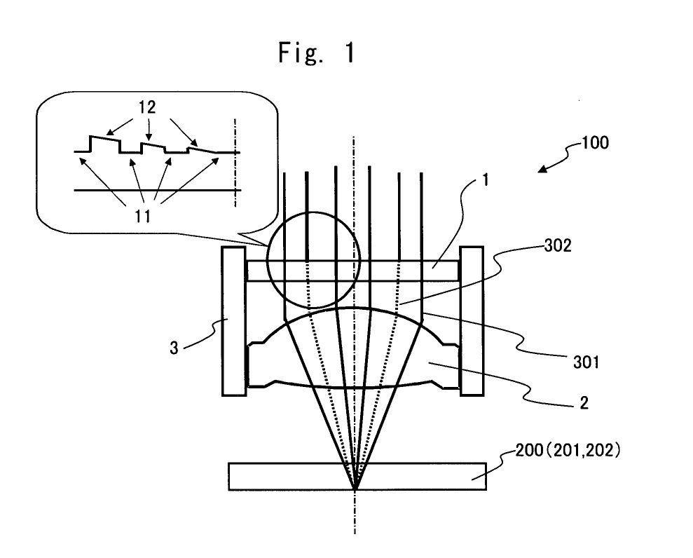

The structure of an objective lens optical system according to the embodiment of the present invention is described hereinafter with reference to FIG. 1. In an objective lens optical system 100 of this embodiment, a light beam splitting element 1 and an objective lens 2 are fixed inside a lens barrel 3 by an UV curable adhesive or the like. The lens barrel 3 is made of plastic, for example.

The incident surface of the light beam splitting element 1 is sectioned into a plurality of regions which are concentric with an optical axis. The number of the plurality of regions is preferably 5 or more. The regions are distinct from each other in shape because they have different surface shapes or there are steps between adjacent regions, for example.

Because each region has the surface shape that is designed to correct aberration for either a Blu-ray Disc or an HDDVD, it is possible to enable compatibility between a Blu-ray Disc and an HDDVD without using a plurality of lenses corresponding to those discs. This eliminates the need for including a mechanism of switching optical paths in an optical pickup, thereby allowing size and cost reduction of an optical pickup.

Specifically, the incident surface of the light beam splitting element 1 is sectioned into two kinds of concentric regions, Blu-ray regions 11 and HDDVD regions 12, which are alternately arranged from the optical axis to the outer side as shown in FIG. 1. The outermost region of the light beam splitting element 1 is the Blu-ray region 11 with a large NA. The Blu-ray region 11 of the light beam splitting element 1 according to this embodiment has a flat surface, and the HDDVD region 12 has a curvature radius so as to act as a concave lens as a whole. The Blu-ray region 11 may have a convex lens surface rather than a flat surface. Further, the Blu-ray region 11 may have a concave lens surface having a negative power as long as it is smaller than a negative power of the HDDVD region 12. The exit surface of the light beam splitting element 1 is a flat surface.

One region of the plurality of Blu-ray regions 11 may be formed to have a different height from another region in the optical axis direction. Specifically, the plurality of Blu-ray regions 11 may have a different board thickness from each other. For example, because the height of the HDDVD region 12, which has a concave lens surface, in the light ray direction becomes larger as it is closer to the outside, the height of the Blu-ray region 11 in the light ray direction also becomes larger as it is closer to the outside, so that a step height between the Blu-ray region 11 and the HDDVD region 12 is small. A difference in height (a difference in board thickness) needs to be mλ (m is an integer) in order to prevent phase shift. This structure enables reduction of a difference in height in the light ray direction, or a step height, between the Blu-ray region 11 and the HDDVD region 12, thereby facilitating the manufacture of a mold and improving the moldability. If the board thickness of the Blu-ray region 11 is changed by mλ, aberration can occur in the portion where a change of mλ is made when the wavelength of an incident light beam or the refractive index of the light beam splitting element 1 varies with a change in ambient temperature. In terms of suppressing the occurrence of such aberration, a step height may be reduced by making parallel shift in the light ray direction without changing the thickness of the Blu-ray region 11 of the light beam splitting element 1.

Although the Blu-ray region 11 and the HDDVD region 12 are arranged alternately in the example of FIG. 1, they are not necessarily arranged alternately as long as they can be distinguished in shape as described earlier. For example, each region may have a structure that corrects chromatic aberration. Alternatively, the Blu-ray region 11 and the HDDVD region 12 may be sectioned radially, not concentrically, from the optical axis. Further, if one surface (incident surface or exit surface) of the light beam splitting element 1 is a flat surface, there is no need to consider the decentering between the incident surface and the exit surface of the light beam splitting element 1, which is advantageous in terms of manufacture. Although one surface of the light beam splitting element 1 is preferably composed only of dedicated regions of the Blu-ray region 11 and the HDDVD region 12 because a light focus position is largely deviated, it is still possible to form a common region for a Blu-ray Disc and an HDDVD in close proximity to the optical axis.

The light beam splitting element 1 may be made of glass or plastic. The use of plastic is preferred in terms of moldability of each region.

The objective lens 2 is designed to correct aberration for a Blu-ray Disc with a thinner substrate. Thus, the objective lens 2 is a dedicated lens for a Blu-ray Disc. The Blu-ray Disc dedicated lens has a large NA and thus permits the formation of a dedicated region for a Blu-ray Disc in the outside region where aberration correction is difficult, which is advantageous compared with the use of an HDDVD dedicated lens.

The objective lens 2 may be made of glass or plastic, for example. The use of glass is preferred because a change in refractive index caused by a change in temperature is smaller and the amount of aberration is lower. More preferably, the objective lens 2 is made of glass with an Abbe number vd>40 because a change in refractive index caused by a change in laser wavelength is smaller and the amount of aberration is yet lower.

The behavior of a light beam that enters the objective lens optical system 100 shown in FIG. 1 is described hereinafter. A light beam (laser light) that is emitted from a light source, which is not shown, enters the objective lens optical system 100 through a beam splitter and a collimator lens. The light that is incident on the objective lens optical system 100 is substantially parallel light.

When placing a Blu-ray Disc 201 in a predetermined position and playing back or recording the disc, the light beam from the light source enters both the Blu-ray region 11 and the HDDVD region 12. The light beam that enters the Blu-ray region 11 is then incident on the objective lens 2 without being refracted because the Blu-ray region 11 has a flat surface. Since the objective lens 2 is designed to correct aberration for the Blu-ray Disc 201 as described earlier, the light beam that enters the objective lens 2 is focused on the information recording surface of the Blu-ray Disc 201.

On the other hand, when playing back or recording the Blu-ray Disc 201, the light beam that enters the HDDVD region 12 is then incident on the objective lens 2 after it is converted into divergent light because the HDDVD region 12 has a concave lens surface. Since it is divergent light, the light beam that enters the objective lens 2 causes large spherical aberration and is thus not focused on the information recording surface of the Blu-ray Disc 201. Therefore, after the light beams are emitted from the light source and enter the objective lens optical system 100, only the light which has passed through the Blu-ray region 11 is focused on the information recording surface of the Blu-ray Disc 201.

When placing an HDDVD 202 in a predetermined position and playing back or recording the disc, the light beam from the light source enters both the Blu-ray region 11 and the HDDVD region 12. The light beam that enters the HDDVD region 12 is then incident on the objective lens 2 after it is converted into divergent light because the HDDVD region 12 has a concave lens surface. Since it is divergent light, the light beam that enters the objective lens 2 has a long focal length and is thus focused on the information recording surface of the HDDVD 202 having a thick substrate with a long working distance.

On the other hand, when playing back or recording the HDDVD 202, the light beam that enters the Blu-ray region 11 is then incident on the objective lens 2 without being refracted because the Blu-ray region 11 has a flat surface. Since the objective lens 2 is designed to correct aberration for the Blu-ray Disc 201 and not to correct aberration for the HDDVD 202 having a different thickness as described earlier, the light beam that enters the objective lens 2 is not focused on the information recording surface of the HDDVD 202. Therefore, after the light beams are emitted from the light source and enter the objective lens optical system 100, only the light which has passed through the HDDVD region 12 is focused on the information recording surface of the HDDVD 202.

A working distance from the objective lens 2 to a disc 200 is disadvantageous for an HDDVD than for a Blu-ray Disc because of its larger substrate thickness. Particularly, when applying the objective lens optical system to a low-profile drive, a focal length of the objective lens optical system is short, which raises the possibility that the objective lens 2 and the disc 200 can come into contact, and it is thus important to maintain a sufficient working distance. In light of this, in the objective lens optical system 100 of this embodiment, the HDDVD region 12 is designed to have a curvature radius so as to act as a concave lens in order to increase the focal length of the HDDVD 202 having a thick substrate, thereby obtaining a sufficient working distance.

As a difference in focal length is larger, a light focus position becomes farther from the Blu-ray region 11 and the HDDVD region 12, which lowers the effect of unwanted light, thereby permitting suitable formation of an optical spot.

In order to increase the recording density of the Blu-ray Disc 201 and the HDDVD 202, a dual/double layer disc which has two information recording surfaces has been developed and put to practical use. In such a dual/double layer disc, a gap between layers is 25±5 μm or 20±5 μm.

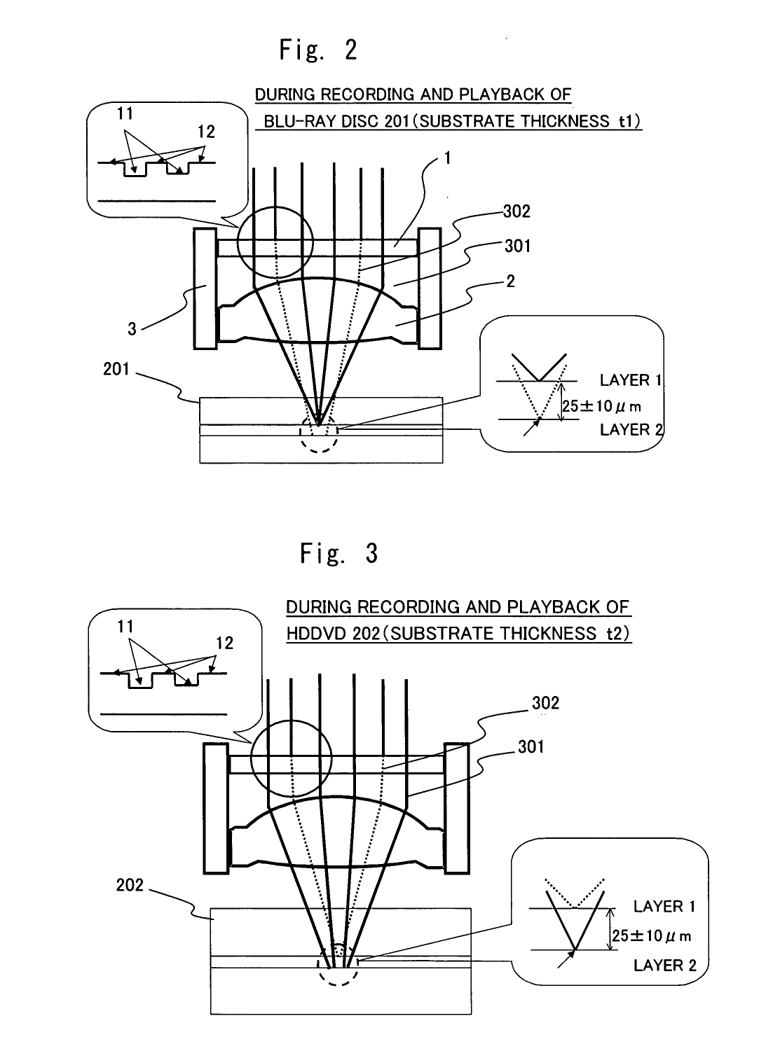

Referring to FIG. 2, it is assumed in this embodiment that the Blu-ray Disc 201 includes a first layer 1 and a second layer 2. When recording or playing back information on the layer 1 of the Blu-ray Disc 201, although a light beam which has passed through the Blu-ray region 11 is focused on the layer 1, a light beam which has passed through the HDDVD region 12 can be focused on the layer 2. If a light beam is accidentally focused on the layer 2 of the Blu-ray Disc 201, it can lead to accidental writing or erasure, focus servo error and so on. In light of this, the HDDVD region 12 of this embodiment has a lens surface that prevents a light beam which has passed through the HDDVD region 12 from being focused on the layer 2 during recording or playback of information on the layer 1 of the Blu-ray Disc 201.

Further, the HDDVD region 12 has a lens surface that prevents a light beam which has passed through the HDDVD region 12 from being focused on the layer 1 during recording or playback of information on the layer 2 of the Blu-ray Disc 201.

Likewise, referring to FIG. 3, it is assumed that the HDDVD 202 includes a first layer 1 and a second layer 2. When recording or playing back information on the layer 1 of the HDDVD 202, although a light beam which has passed through the HDDVD region 12 is focused on the layer 1, a light beam which has passed through the Blu-ray region 11 can be focused on the layer 2. If a light beam is accidentally focused on the layer 2 of the HDDVD 202, it can lead to accidental writing or erasure, focus servo error and so on. In light of this, the Blu-ray region 11 of this embodiment has a lens surface that prevents a light beam which has passed through the Blu-ray region 11 from being focused on the layer 2 during recording or playback of information on the layer 1 of the HDDVD 202.

Further, the Blu-ray region 11 has a lens surface that prevents a light beam which has passed through the Blu-ray region 11 from being focused on the layer 1 during recording or playback of information on the layer 2 of the HDDVD 202.

The light beam splitting element 1 according to this embodiment is optically designed so as to achieve suitable recording and playback of a dual/double layer disc as well.

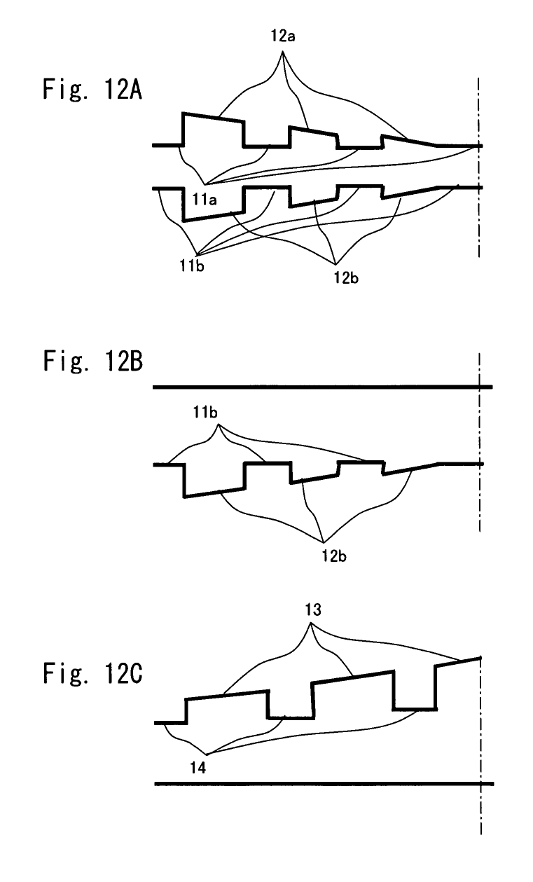

FIGS. 12A to 12C show alternative examples of the light beam splitting element 1. In the example shown in FIG. 12A, the incident surface of the light beam splitting element 1 includes a Blu-ray region 11a and an HDDVD region 12a, and the exit surface includes a Blu-ray region 11b and an HDDVD region 12b. The HDDVD region 12b has a curvature radius so as to act as a concave lens, and the Blu-ray region 11b has a flat surface. If both the incident surface and the exit surface have a lens surface in some of their regions as in the example of FIG. 12A, the view angle characteristics improves compared with the case where either one surface has a lens surface.

In the example shown in FIG. 12B, the incident surface is a flat surface, and the exit surface includes the Blu-ray region 11b and the HDDVD region 12b. The Blu-ray region 11b has a flat surface, and the HDDVD region 12b has a curvature radius so as to act as a concave lens.

In the example shown in FIG. 12C, the exit surface is a flat surface, and the incident surface includes a Blu-ray region 13 and an HDDVD region 14. The Blu-ray region 13 has a curvature radius so as to act as a convex lens having a positive power, and the HDDVD region 14 has a curvature radius so as to act as a convex lens. Alternatively, the incident surface may be a flat surface, and the exit surface may include the Blu-ray region 13 and the HDDVD region 14. Further, both the incident surface and the exit surface may have the Blu-ray region 13 and the HDDVD region 14.

The structures shown in FIGS. 12A to 12C also enable recording or playback of optical recording media having different thicknesses with a light beam of the same wavelength.

Although some regions on at least one surface of the light beam splitting element 1 have a curvature radius so as to act as a concave lens or a convex lens in the above-described example, it is not limited thereto, and a diffractive structure may be formed to thereby generate a negative power or a positive power. Further, although the surface shapes of the light beam splitting element 1 and the objective lens 2 are designed on the assumption that parallel light is incident on the light beam splitting element 1 in the above-described example, it is not limited thereto, and the surface shapes of the light beam splitting element 1 and the objective lens 2 may be designed so that divergent light or convergent light is incident on the light beam splitting element 1, and output light is focused on the objective lens 2. Further, although the light beam splitting element 1 and the objective lens 2 are configured as different parts in the above-described example, they may be in an integral form such that the surface of the objective lens 2 has the function of the light beam splitting element 1.

The shapes of the regions may be in any combination. For example, possible cases include that the Blu-ray region 13 has a concave lens shape and the HDDVD region 14 has a convex lens shape, or the Blu-ray region 13 has a convex lens shape and the HDDVD region 14 has a concave lens shape. In this case, the objective lens may be any type of lens. Another possible case is that the Blu-ray region 13 has a flat plate shape and the HDDVD region 14 has a concave lens shape or a convex lens shape. In this case, the objective lens is a Blu-ray dedicated lens. Yet another possible case is that the HDDVD region 14 has a flat plate shape and the Blu-ray region 13 has a concave lens shape or a convex lens shape. In this case, the objective lens is an HDDVD dedicated lens. On the other hand, the case that the Blu-ray region 13 has a concave lens shape and the HDDVD region 14 also has a concave lens shape, or the Blu-ray region 13 has a convex lens shape and the HDDVD region 14 also has a convex lens shape is not impossible, but not practical. The case that the Blu-ray region 13 and the HDDVD region 14 both have a flat plate shape having no power is not applicable.

### Example

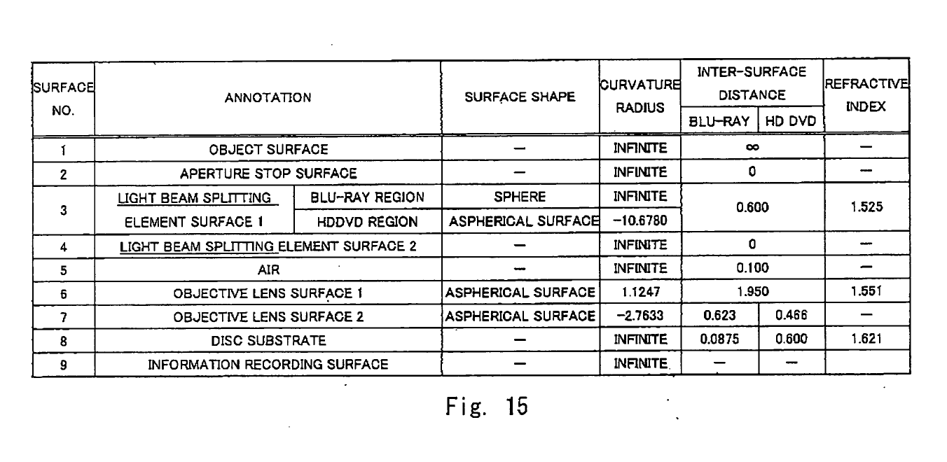

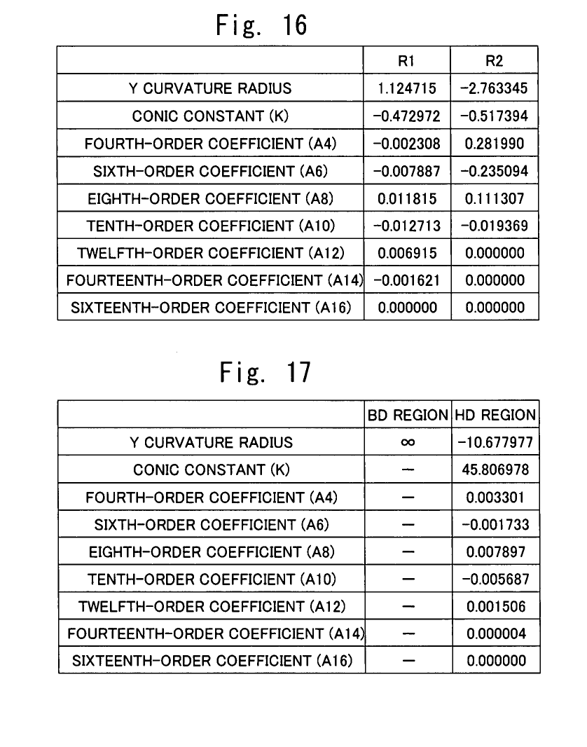

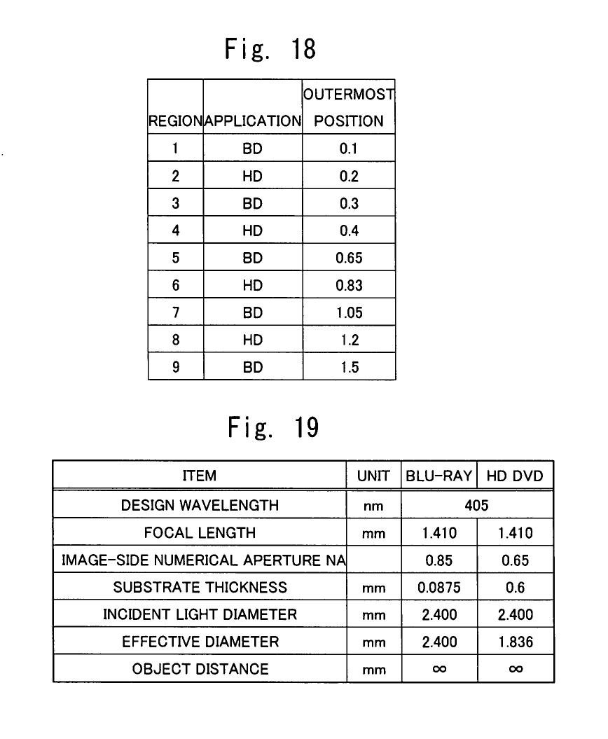

FIGS. 14 and 15 show a design result and lens data, respectively, of the objective lens optical system according to an example of the present invention. FIG. 16 shows surface shape data of an objective lens according to this example. FIG. 17 shows surface shape data of a light beam splitting element according to this example. FIG. 18 shows the position of regions in the light beam splitting element of this example. Referring first to FIG. 14, the focal length of a Blu-ray Disc is f=1.765 mm, and the focal length of an HDDVD is f=1.840 mm, and thus the focal length of an HDDVD is longer than that of a Blu-ray Disc. In the present example, the curvature radius of the HDDVD region is set so as to act as a concave lens, and the focal length is set to be longer than that of a Blu-ray Disc. As a result, a longer working distance can be obtained compared with the case where the HDDVD region has a flat surface or a convex lens surface.

As shown in FIG. 14, an image-side numerical aperture NA is different between a Blu-ray Disc and an HDDVD, which is 0.85 and 0.65, and therefore an effective diameter is also different. In a related technique that enables compatibility between a DVD and a CD or the like, a wavelength is different and it is thus possible to change the effective diameter according to the wavelength with use of an aperture stop that is used in a wavelength selection filter or the like.

However, because the present invention is intended to achieve compatibility while using the same wavelength, a wavelength selection filter or the like cannot be used. Thus, in the present example, a Blu-ray region outside the effective diameter of an HDDVD is designed to have a shape that causes spherical aberration during use of an HDDVD, and the focal lengths of a Blu-ray Disc and an HDDVD are set to be different from each other to make the defocusing that causes large wavefront aberration, thereby creating the function of an aperture stop. It is thereby possible to change the effective diameter without the need for placing an aperture stop in an optical pickup.

The surface shape data shown in FIG. 16 are indicated by the following expression:

$$z ( sag ) = \frac{{Ch}^{2}}{1 + \sqrt{1 - ( K + 1 ) {C}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} \qquad Expression 1$$

In the above Expression 1, a distance (sag) of an aspherical surface from a tangent plane on an optical axis in coordinate points on the aspherical surface where a height from the optical axis is h is Zj (h), a curvature (1/curvature radius) of the aspherical surface on the optical axis is C, a constant of the cone is K, and the fourth- to sixteenth-order aspheric coefficients are A4, A6, A8, A10, A12, A14 and A16, respectively.

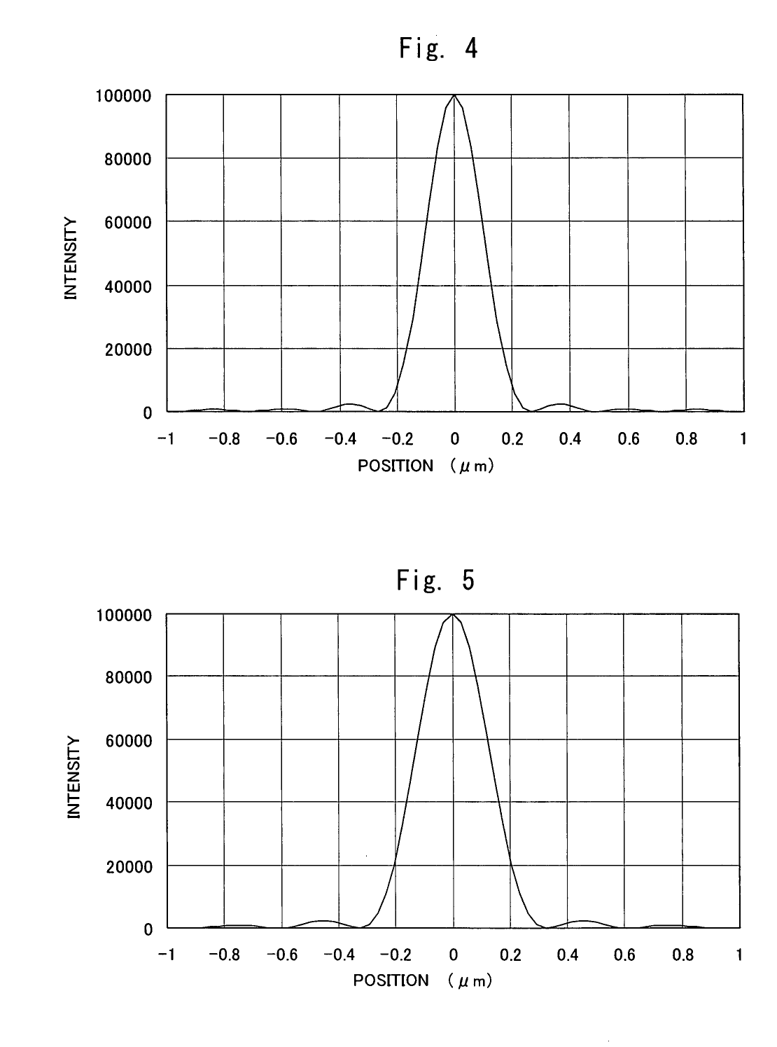

FIGS. 4 and 5 show optical spot charts of a Blu-ray Disc and an HDDVD, respectively, in the objective lens optical system of this example. A 1/e2 spot diameter is 0.360 μm for a Blu-ray Disc and 0.465 μm for an HDDVD. A sidelobe is 2.43% for a Blu-ray Disc and 2.61% for an HDDVD.

A theoretical value of the 1/e2 spot diameter is 0.39 μm or lower for a Blu-ray Disc and 0.51 μm or lower for an HDDVD. Thus, an optical spot that causes no problem in practical use can be obtained in the objective lens optical system of this example. The 1/e2 spot diameter and the sidelobe can be controlled by changing the surface shape of regions or the number of regions in the light beam splitting element according to the present invention.

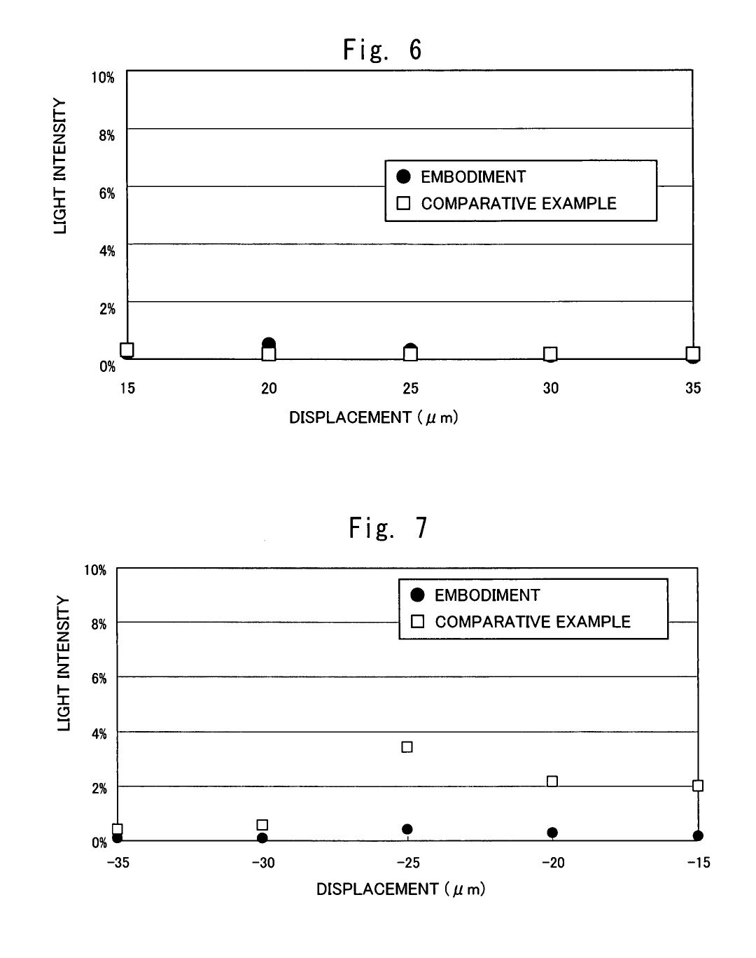

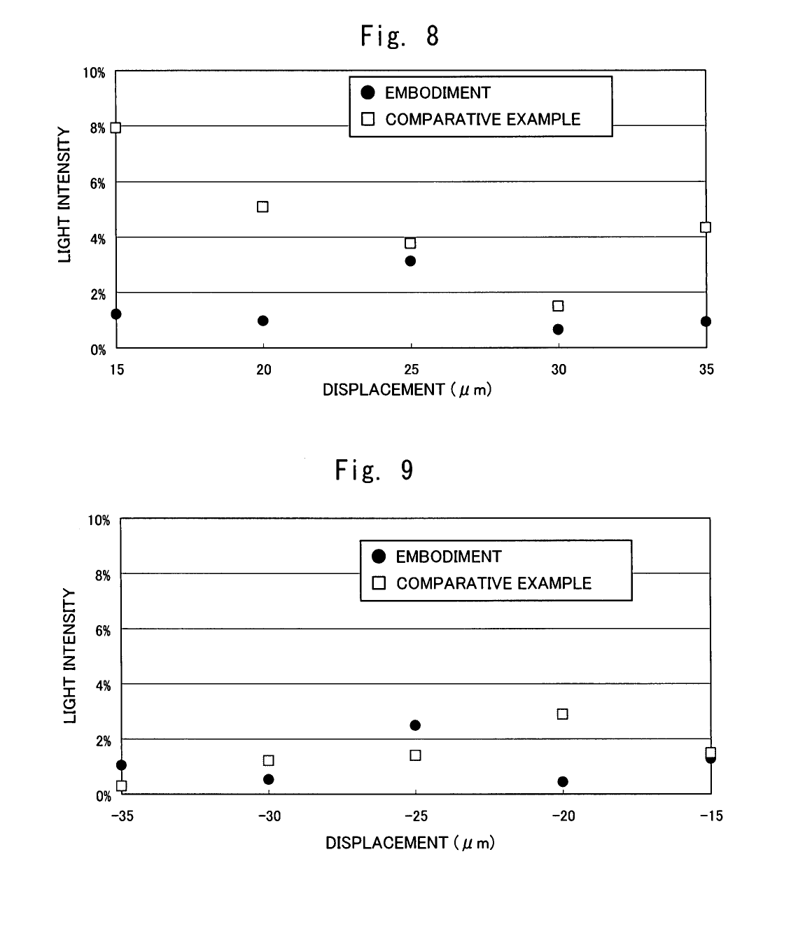

FIGS. 6 to 9 show the dependence of an optical spot intensity on a disc thickness in order to check the adaptability of the objective lens optical system of this example to a dual/double layer disc. The graphs indicate the intensity of an optical spot, during recording or playback of information on a certain layer, at the position +15 to +35 μm (FIGS. 6 and 8) or −15 to −35 μm (FIGS. 7 and 9) away from the layer on which recording or playback is performed when the light intensity in the layer where recording or playback is performed is 100%. If the intensity is higher, a light beam is focused on a different layer, which leads to accidental writing or erasure, focus servo error and so on. For comparison with the result of this example, the result of a comparative example, which is described later, is also shown. As shown in the graphs, the use of the objective lens optical system of this example suppresses the light focus on another layer. Accordingly, the use of the objective lens optical system of the present invention enables suitable recording or playback of a dual/double layer disc as well.

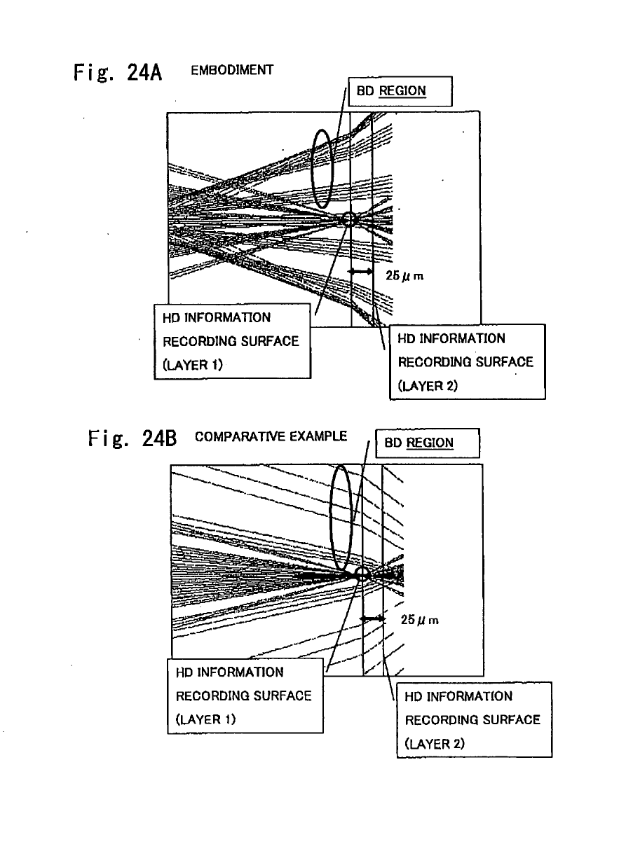

FIG. 24A shows light rays when recording or playing back information on the layer 1 of an HDDVD with use of the objective lens optical system of this example. As shown in FIG. 24A, the light beam which has passed through the HDDVD region 12 and the objective lens 2 is focused on the layer 1, but the light beam which has passed through the Blu-ray region 11 and the objective lens 2 is focused on the position which is far away from the layer 2. Thus, the use of the objective lens optical system of the present invention enables suitable recording or playback of a dual/double layer disc as well.

Whether a light beam is focused on a prescribed position can be also checked using a sum signal in a detector. If a light beam is focused on a defocusing position of the above range, the intensity of a sum signal increases at the light focus position. It is thus determined that light focus is suppressed if the intensity of a sum signal in a given range is one-fifth or lower, or preferably one-tenth or lower, of the intensity of a sum signal on the information recording surface. The inter-surface distance in the surface number 7 shown in FIG. 15 indicates a working distance in this example, which is 0.623 mm for a Blu-ray Disc and 0.466 mm for an HDDVD. These values satisfy “0.3 mm or longer”, which is the condition of a preferred working distance for solving the problem that an optical head and a disc are come into contact. On the other hand, in the comparative example, which is described later, a working distance is 0.4614 mm for a Blu-ray Disc and 0.1453 mm for an HDDVD, which does not satisfy the condition.

### Comparative Example

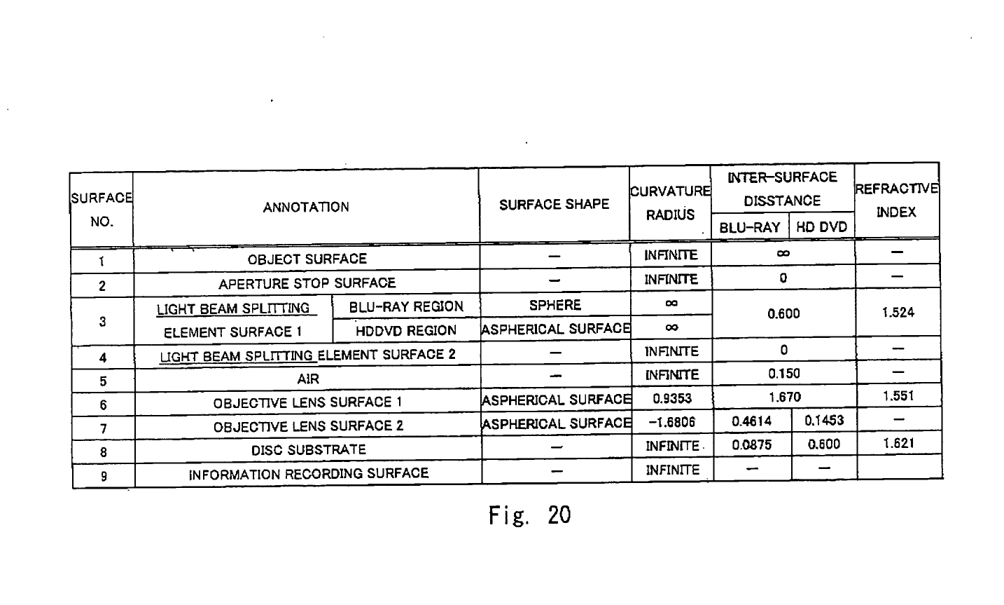

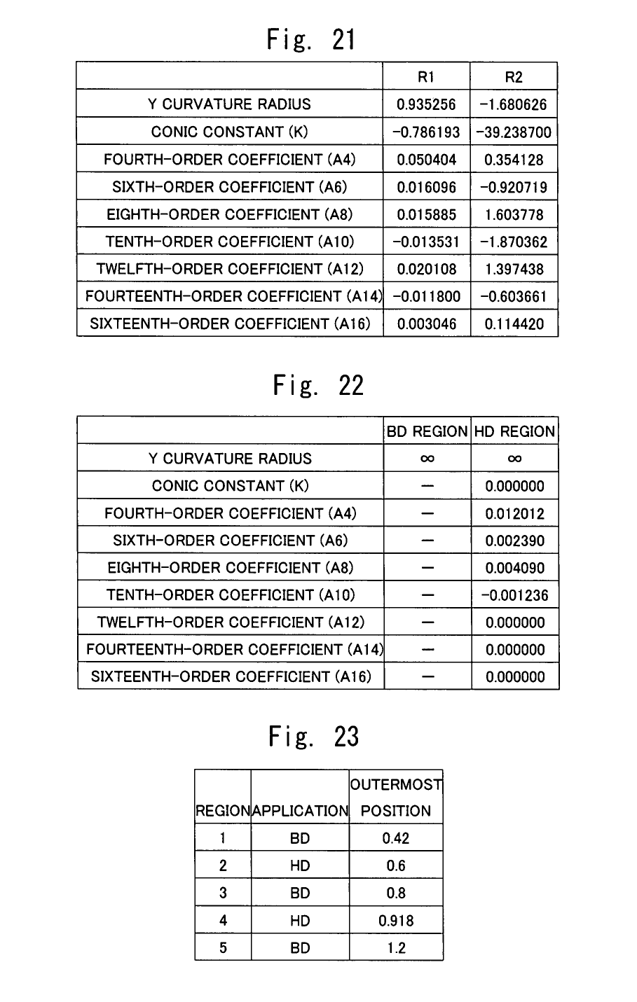

FIGS. 19 and 20 show a design result and lens data, respectively, of the objective lens optical system according to a comparative example. FIG. 21 shows surface shape data of an objective lens according to the comparative example. FIG. 22 shows surface shape data of a light beam splitting element according to the comparative example. FIG. 23 shows the position of regions in the light beam splitting element of the comparative example. As shown in FIG. 19, the focal length is the same between a Blu-ray Disc and an HDDVD in the comparative example, which is different from the above-described example.

The surface shape of the light beam splitting element is such that the curvature radius is the same between a Blu-ray region and an HDDVD region, and only the aspheric coefficient of the HDDVD region is used so as to correct only the spherical aberration that occurs due to a difference in substrate thickness between a Blu-ray Disc and an HDDVD.

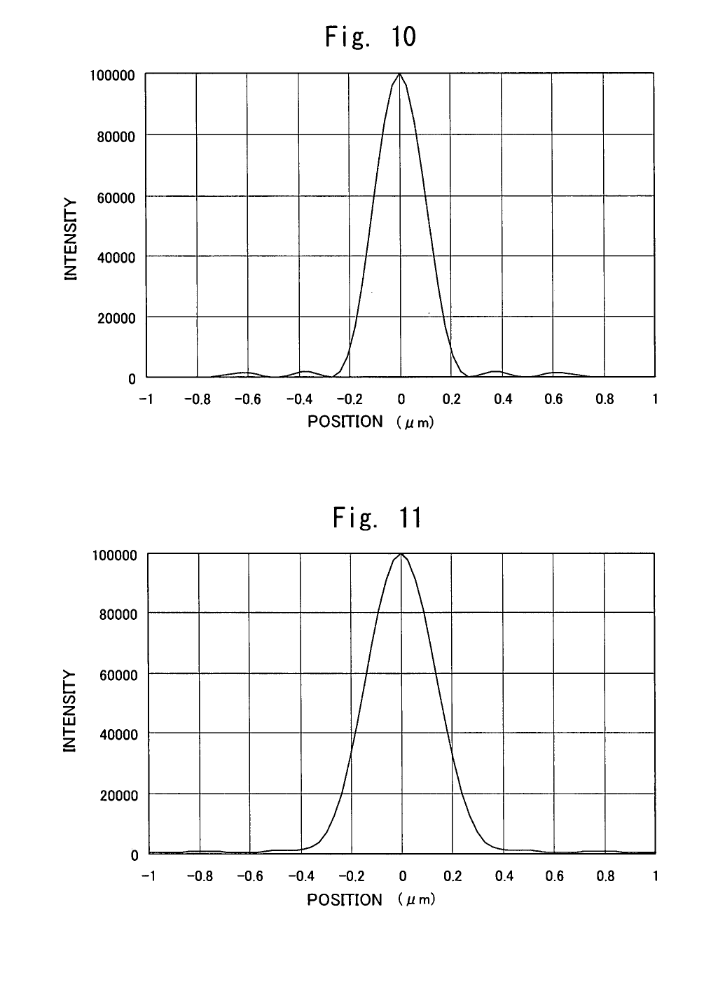

FIGS. 10 and 11 show optical spot charts of a Blu-ray Disc and an HDDVD, respectively, in the objective lens optical system of the comparative example. A 1/e2 spot diameter is 0.377 μm for a Blu-ray Disc and 0.515 μm for an HDDVD. A sidelobe is 1.88% for a Blu-ray Disc and 1.76% for an HDDVD, which present no problem.

As mentioned above, FIGS. 6 to 9 show the dependence of an optical spot intensity on a disc thickness. An optical spot with an intensity of substantially 4% is formed at the position of about −20 μm in a Blu-ray disc and an optical spot with an intensity of substantially 8% is formed at the position of about 15 μm in an HDDVD. Overall, optical spots with a higher intensity than that of the above-described example are formed in this comparative example. Thus, in the objective lens optical system of the comparative example, accidental writing or erasure, focus servo error and so on are likely to occur when using a dual/double layer disc, which hampers suitable recording or playback of a dual/double layer disc.

FIG. 24B shows light rays when recording or playing back information on the layer 1 of an HDDVD with use of the objective lens optical system of the comparative example. As shown in FIG. 24B, the light beam which has passed through the HDDVD region 12 and the objective lens 2 is focused on the layer 1, and the light beam which has passed through the Blu-ray region 11 and the objective lens 2 is also focused on the position near the layer 2. Thus, accidental writing or erasure, focus servo error and so on are likely to occur when using a dual/double layer disc in the objective lens optical system of the comparative example, which hampers suitable recording or playback of a dual/double layer disc.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An objective lens optical system including a light beam splitting element and an objective lens, and configured to focus a light beam with a wavelength λ on an information recording surface of a first optical recording medium having a transparent substrate with a thickness t1 and to focus a light beam with a wavelength λ on an information recording surface of a second optical recording medium having a transparent substrate with a thickness t2 (t1<t2), wherein
one of the first optical recording medium and the second optical recording medium includes two or more layers of information recording surfaces,
at least one surface of the light beam splitting element is sectioned into a first region designed to focus a light beam on an information recording surface of the first optical recording medium through the objective lens, and a second region designed to focus a light beam on an information recording surface of the second optical recording medium through the objective lens, and
at least one region has a negative or positive power to prevent a light beam having passed through one of the first region and the second region from being focused near a light focus position of a light beam having passed through another one of the first region and the second region in a corresponding optical recording medium.

2. The objective lens optical system according to claim 1, wherein
the first optical recording medium at least includes a first information recording surface and a second information recording surface, and
a surface shape of each region is designed to suppress a light beam having passed through the second region from being focused on the second information recording surface of the first optical recording medium when focusing a light beam on the first information recording surface of the first optical recording medium.

3. The objective lens optical system according to claim 1, wherein
the second optical recording medium at least includes a first information recording surface and a second information recording surface, and
a surface shape of each region is designed to suppress a light beam having passed through the first region from being focused on the second information recording surface of the second optical recording medium when focusing a light beam on the first information recording surface of the second optical recording medium.

4. The objective lens optical system according to claim 1, wherein
a surface shape of each region is designed to suppress a light beam having passed through the second region from being focused on ranges from t1+0.015 mm to t1+0.035 mm and from t1−0.015 mm to t1−0.035 mm when focusing a light beam on an information recording surface of the first optical recording medium, and to suppress a light beam having passed through the first region from being focused on ranges from t2+0.015 mm to t2+0.035 mm and from t2−0.010 mm to t2−0.035 mm when focusing a light beam on an information recording surface of the second optical recording medium.

5. The objective lens optical system according to claim 1, wherein
the second region has a curvature radius so as to act as a concave lens.

6. The objective lens optical system according to claim 1, wherein
the second region has a diffractive structure.

7. The objective lens optical system according to claim 1, wherein
the first region has a flat surface.

8. The objective lens optical system according to claim 7, wherein
one region of a plurality of first regions has a different height from another region in an optical axis direction, and a difference in the height is mλ (m is an integer).

9. The objective lens optical system according to claim 1, wherein
a surface of the light beam splitting element opposite to the surface sectioned into a plurality of regions is a flat surface.

10. The objective lens optical system according to claim 1, wherein
a plurality of regions formed on one surface of the light beam splitting element are sectioned concentrically with an optical axis.

11. The objective lens optical system according to claim 1, wherein
a focal length for the second optical recording medium is longer than a focal length for the first optical recording medium.

12. The objective lens optical system according to claim 1, wherein
a lens surface of the objective lens is designed to correct aberration for the first optical recording medium.

13. The objective lens optical system according to claim 12, wherein
a numerical aperture NA corresponding to the first optical recording medium is larger than a numerical aperture NA corresponding to the second optical recording medium.

14. A light beam splitting element disposed on a light incident side of an objective lens, and configured to focus a light beam with a wavelength λ on an information recording surface of a first optical recording medium having a transparent substrate with a thickness t1 and to focus a light beam with a wavelength λ on an information recording surface of a second optical recording medium having a transparent substrate with a thickness t2 (t1<t2), wherein
one of the first optical recording medium and the second optical recording medium includes two or more layers of information recording surfaces,
at least one surface of the light beam splitting element is sectioned into a first region designed to focus a light beam on an information recording surface of the first optical recording medium through the objective lens, and a second region designed to focus a light beam on an information recording surface of the second optical recording medium through the objective lens, and
at least one region has a negative or positive power to prevent a light beam having passed through one of the first region and the second region from being focused near a light focus position of a light beam having passed through another one of the first region and the second region in a corresponding optical recording medium.

15. An objective lens optical system including a light beam splitting element and an objective lens, and configured to focus a light beam with a wavelength λ on an information recording surface of a first optical recording medium having a transparent substrate with a thickness t1 and to focus a light beam with a wavelength λ on an information recording surface of a second optical recording medium having a transparent substrate with a thickness t2 (t1<t2), wherein at least one surface of the light beam splitting element is sectioned into a first region designed to focus a light beam on an information recording surface of the first optical recording medium through the objective lens, and a second region designed to focus a light beam on an information recording surface of the second optical recording medium through the objective lens, and
the second region has a negative power.

16. The objective lens optical system according to claim 15, wherein
the second region has a curvature radius so as to act as a concave lens.

17. The objective lens optical system according to claim 15, wherein
the first region has a smaller negative power than the second region.

18. The objective lens optical system according to claim 15, wherein
the second region has a diffractive structure.

19. The objective lens optical system according to claim 15, wherein
the first region has a flat surface.

20. The objective lens optical system according to claim 19, wherein
one region of a plurality of first regions has a different height from another region in an optical axis direction, and a difference in the height is mλ (m is an integer).

21. The objective lens optical system according to claim 15, wherein
a surface of the light beam splitting element opposite to the surface sectioned into a plurality of regions is a flat surface.

22. The objective lens optical system according to claim 15, wherein
a plurality of regions formed on one surface of the light beam splitting element are sectioned concentrically with an optical axis.

23. The objective lens optical system according to claim 15, wherein
a focal length for the second optical recording medium is longer than a focal length for the first optical recording medium.

24. The objective lens optical system according to claim 15, wherein
a lens surface of the objective lens is designed to correct aberration for the first optical recording medium.

25. A light beam splitting element disposed on a light incident side of an objective lens, and configured to focus a light beam with a wavelength on an information recording surface of a first optical recording medium having a transparent substrate with a thickness t1 and to focus a light beam with a wavelength λ on an information recording surface of a second optical recording medium having a transparent substrate with a thickness t2 (t1<t2), wherein
at least one surface of the light beam splitting element is sectioned into a first region designed to focus a light beam on an information recording surface of the first optical recording medium through the objective lens, and a second region designed to focus a light beam on an information recording surface of the second optical recording medium through the objective lens, and
the second region has a negative power.
